(19) United States
(12) Patent Application Publication
(10) Pub. No.: US 2011/0297100 A1
(43) Pub. Date: Dec. 8, 2011

(54) UNDERCOAT RAKE FOR GROOMING A FURRED ANIMAL

(75) Inventor: Edward P. Dennis, Conifer, CO (US)

(73) Assignee: TOPET (H.K.) CO., LIMITED, Kowloon (HK)

(21) Appl. No.: 12/793,506

(22) Filed: Jun. 3, 2010

(51) Int. Cl. A01K 13/00

(52) U.S. Cl. 119/601; 119/625

(57) ABSTRACT

An undercoat rake adapted for use in grooming a furred animal. The undercoat rake includes grooming teeth comprising at least two different types of grooming teeth, each having a base portion, a tip portion, and a shoulder between the base portion and the tip portion. First teeth of the two different types of grooming teeth may have a tip portion that is greater in length than the corresponding tip portion of second teeth to create a variable depth grooming profile. The disclosed structure advantageously removes undercoat fur of a furred animal that has been shed or is soon to be shed. The variable depth grooming profile has been found to be highly effective to rapidly and efficiently thin the undercoat of a furred animal.

### FIELD OF THE INVENTION

The present invention relates to an undercoat rake for use in the grooming of a furred animal, such as a dog. In particular, the invention is directed to an undercoat rake that may include a plurality of grooming teeth with a base portion, a tip portion, and a shoulder disposed between the base portion and the tip portion, wherein the length of the tip portion of some grooming teeth is greater than the length of the tip portion of other grooming teeth.

### BACKGROUND OF THE INVENTION

Grooming an animal is important to the animal's health and appearance. Grooming can also provide enjoyment to the groomer, which in many cases is the owner of the animal. Grooming may also allow for emotional bonding between the animal and groomer. Accordingly, there exists a need for products and apparatus in order to assist an owner or groomer in the grooming of an animal.

Some animals have a coat of fur that includes an undercoat and a topcoat. For example, many dog breeds have a topcoat and an undercoat. Generally, the topcoat includes rough, somewhat weather resistant fur that functions to repel water, wind, and other dirt or debris. The undercoat usually comprises thick, warm, down-like fur made up of generally shorter hairs than those of the topcoat. The undercoat fur is usually dense enough to resist penetration of water to the skin of the animal and provides an insulating layer to assist in keeping the animal warm. As such, many animals, and particularly dogs, seasonally grow a dense undercoat. In turn, the undercoat is also seasonally shed.

Shedding occurs because each follicle of hair in an animal's coat follows a cycle of growing, dying, and being replaced by another follicle. When the follicle dies, the hair becomes detached, or shed. This shedding process may occur constantly. The rate at which fur is shed may be affected by such factors as the breed, age and environment of the animal. For instance, as stated above, the undercoat of the animal may change seasonally, such that in cooler months of the year the undercoat grows denser in order to provide insulation. Accordingly, during warmer months, a portion of the undercoat may be shed.

While shedding of the undercoat occurs naturally, it may be advantageous to assist in the removal of the undercoat by grooming the animal. For instance, if a dog is kept indoors, the owner may wish to assist or accelerate the shedding process by brushing or combing the fur of the dog in order to remove loose fur or fur that will soon be shed. The grooming of a dog to remove the undercoat may be conducted in a location determined by the owner. The location of grooming may be controlled such that the grooming process is conducted to prevent continuous shedding within the owner's home or other location where shedding might be undesirable. Shedding can thus be controlled such that the owner may be able to selectively groom the dog in order to prevent the undercoat from being shed indoors.

Preventing an animal from shedding indoors presents several advantages versus allowing natural shedding. For many individuals, loose fur of the animal may be an allergen such that limiting the amount of fur shed indoors may prevent unwanted allergy symptoms. Further, shed fur may cling to upholstery or clothing and may require much time and effort to remove the fur from such surfaces.

Additionally, assisting in the normal process of shedding through grooming may benefit the health and comfort of the animal. An excessive amount of residual undercoat may cause the animal to endure heat stress more readily due to the insulating properties of the undercoat. Moreover, grooming and undercoat removal may prevent the animal's fur from becoming tangled or matted. Grooming may also calm or relax the animal.

### SUMMARY OF THE INVENTION

There exists a need for tools that are adapted to efficiently thin the undercoat of a furred animal in order to prevent unwanted or uncontrolled shedding. Accordingly, an undercoat rake for grooming a furred animal, including the removal of undercoat fur that has been shed or is soon to be shed is provided. The undercoat rake disclosed herein may provide for effective undercoat removal when used in grooming.

One embodiment includes an undercoat rake for grooming a furred animal. The undercoat rake may include a rake body and grooming teeth operatively affixed to the rake body. The grooming teeth may comprise a plurality of first teeth that may have a base portion adjacent to and extending from the rake body, a tip portion at a distal end, and a shoulder disposed between the base portion and the tip portion. The grooming teeth may also include a plurality of second teeth. The second teeth may have a base portion adjacent to and extending from the rake body, a tip portion at a distal end, and a shoulder disposed between the base portion and the tip portion. The first teeth have a different profile than the second teeth, and in one aspect the length of the tip portion of the first teeth may be greater than the length of the tip portion of the second teeth.

Another embodiment includes an undercoat rake for grooming a furred animal that may include a rake body including a head portion having a length along a major axis of the head portion and a handle portion having a longitudinal axis. The head portion may be arranged such that the major axis of the head portion may be substantially perpendicular to the longitudinal axis of the handle portion. The undercoat rake may include grooming teeth operatively affixed to the rake body along the length of the head portion. The grooming teeth may include a plurality of first teeth that may have a base portion adjacent to and extending from the rake body, a tip portion at a distal end, and a shoulder disposed between the base portion and the tip portion. The grooming teeth may also include a plurality of second teeth that are alternately disposed with the first teeth. The second teeth may have a base portion adjacent to and extending from the rake body, a tip portion at a distal end, and a shoulder disposed between the base portion and the tip portion. The first teeth have a different profile than the second teeth and in one aspect the length of the tip portion of the first teeth may be greater than the length of the tip portion of the second teeth.

In addition, variations and refinements may exist to the embodiments presented herein. These combinations and refinements may be made in any combination. For example, in one aspect first teeth and second teeth may be alternately disposed in any pattern along the length of the head portion. Moreover, first teeth and second teeth may alternate at adjacent tooth positions along the length of the head portion. According to another aspect, adjacent grooming teeth may be spaced apart by at least about 2 mm and not greater than about 5 mm. In another aspect, first teeth and second teeth may be substantially the same total length. Alternatively, the total length of first teeth and second teeth may be different. In yet another aspect, a handle portion may be provided for manipulation of the undercoat rake. According to still another aspect, the tip portion of first teeth may be at least about 15% longer than the tip portion of second teeth, such as at least about 40% longer. In another aspect, the total length of the grooming teeth may be at least about 10 mm and not greater than about 40 mm, such as not greater than about 25 mm.

Another embodiment includes a method for grooming a furred animal. The method may include providing an undercoat rake according to any of the forgoing embodiments or aspects, positioning the undercoat rake adjacent to the animal such that grooming teeth engage the fur of the animal, and moving the undercoat rake with respect to the animal while maintaining engagement of the grooming teeth with the fur such that the grooming teeth act upon the fur passing therebetween to remove loose hairs from the fur of the animal, thus grooming the animal.

The embodiments presented are advantageous because it has been found that the shape and arrangement of the grooming teeth are highly effective to rapidly and efficiently thin the undercoat of a furred animal. The first and second grooming teeth may include base portions and/or tip portions of different lengths such that a combination of first and second grooming teeth form a variable depth grooming profile as the grooming teeth are moved through the animal's fur. As the first and second grooming teeth have different profiles, and simultaneously act upon the animal's fur at different depths, they act in coordination to pull and collect more loose undercoat fur than an undercoat rake having grooming teeth with the same depth profile.

### BRIEF DESCRIPTION OF THE DRAWINGS

FIG. 1 is a perspective view of an embodiment of an undercoat rake.

FIG. 2 is a bottom view of the embodiment of an undercoat rake of FIG. 1.

FIG. 3 is a side view of the embodiment of an undercoat rake of FIG. 1.

FIG. 4 is a front view of the embodiment of an undercoat rake of FIG. 1.

FIG. 5 is a schematic view of adjacent grooming teeth that are useful in an embodiment of an undercoat rake.

FIG. 6 is a front view of another embodiment of an undercoat rake.

FIG. 7 is a schematic view of adjacent grooming teeth that are useful in another embodiment of an undercoat rake.

FIG. 8 is a front view of yet another embodiment of an undercoat rake.

FIG. 9 is a schematic view of adjacent grooming teeth that are useful in yet another embodiment of an undercoat rake.

### DETAILED DESCRIPTION

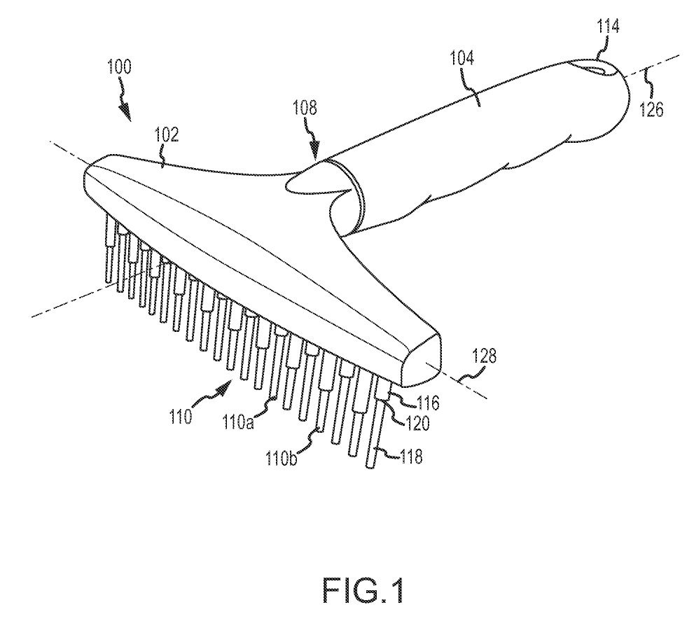

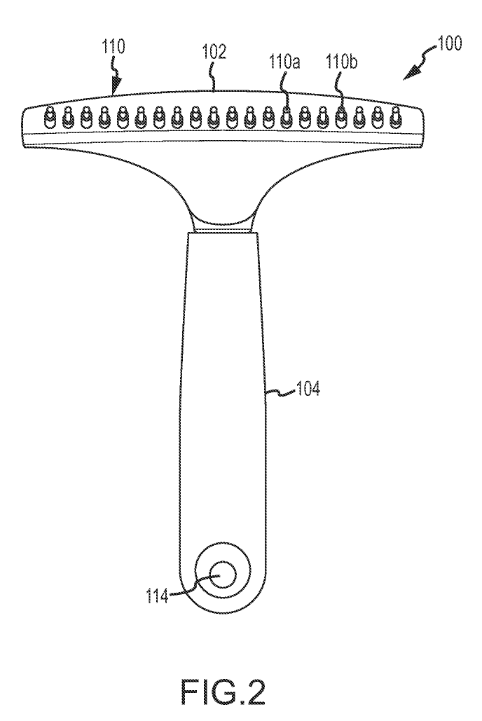

FIGS. 1-4 illustrate an embodiment of an undercoat rake that is adapted for removal of undercoat fur from a furred animal. The undercoat rake 100 may include a rake body 108 that may further include a head portion 102 that may be operatively attached to a handle portion 104. Grooming teeth 110 may include a plurality of first teeth 110a and a plurality of second teeth 110b that may be operatively affixed to and extend from the rake body 108. The first teeth 110a and the second teeth 110b may have a base portion 116 and a tip portion 118 with a shoulder 120 disposed between the base portion 116 and the tip portion 118, where the corresponding base and/or tip portions of first teeth 110a and second teeth 110b may be different lengths. In this regard, first teeth 110a and second teeth 110b may comprise different grooming depth profiles that in combination (e.g., when disposed in an alternating relationships) are advantageous for grooming a furred animal, whereby the different depth profiles of first teeth 110a and second teeth 110b may coordinate to form a varied depth raking profile when moved through the fur of an animal.

The rake body 108 of the undercoat rake 100 may include a head portion 102 and a handle portion 104. The handle portion 104 may include a longitudinal axis 126 along the length of the handle portion 104. The handle portion 104 may be designed so that a user may grip and manipulate the handle portion 104 in order to control the undercoat rake 100 during use (e.g., by varying pressure, angle, depth etc. of the grooming teeth 110 with respect to the animal's fur).

The head portion 102 and the handle portion 104 may be arranged in a variety of ways. For example, the head portion 102 may include a length along a major axis 128 of the head portion 102 and the major axis 128 may be arranged substantially perpendicular to the longitudinal axis 126 of the handle portion 104 to form a “T”-shaped rake body 108 as shown in FIG. 1. Alternatively, a head portion may be arranged such that a major axis is substantially parallel to a longitudinal axis of a handle portion. In this manner, an undercoat rake may comprise a substantially elongate rake body.

The handle portion 104 may include an aperture 114 for mounting and storing the undercoat rake 100. The head portion 102 and handle portion 104 may be constructed of the same material or different materials. For instance, the head portion 102 may be made of polymer, metal, wood, any other suitable material, or a combination thereof. The handle portion 104 may also be made of polymer, metal, wood, any other suitable material, or a combination thereof.

The undercoat rake 100 may include first teeth 110a and second teeth 110b operatively affixed to the rake body 108. The grooming teeth 110 may be affixed to the undercoat rake 100 such that the grooming teeth 110 may be disposed for engagement with the fur of a furred animal. As such, the grooming teeth 110 can be moved along the body of the furred animal such that the grooming teeth 110 maintain engagement with the fur of the animal to accomplish removal of the animal's fur that has been or is soon to be shed.

The grooming teeth 110 may be affixed to the head portion 102 such that the grooming teeth 110 may engage the fur of an animal when a user grasps the handle portion 104. The grooming teeth 110 may be arranged along the length of the head portion 102 corresponding to the major axis 128. In one embodiment, the grooming teeth 110 may be arranged in a generally linear fashion along the length of the head portion 102. In an alternative embodiment, grooming teeth may be arranged radially about a head portion along a length thereof. Accordingly, grooming teeth may radiate from a cylindrical head portion such that grooming teeth both extend along and around the cylindrical head portion. Alternatively, grooming teeth may be staggered in various respects along a length of a head portion. In any regard, grooming teeth may be arranged in any fashion that allows for the interaction of grooming teeth with an animal's fur.

The grooming teeth 110 may be constructed of wood, polymer, metal, any other suitable material, or a combination thereof. By suitable material, it is to be understood that the material from which the grooming teeth 110 are constructed may be substantially rigid such that upon movement of the grooming teeth 110 with respect to the fur of the animal there is substantially no deflection of the grooming teeth 110 along the length of the grooming teeth 110 from the force of the fur acting upon the grooming teeth 110 that would substantially inhibit removal of fur by the grooming teeth 110. In one embodiment, the grooming teeth 110 may be metallic. By way of example, the grooming teeth 110 may be constructed from a rust and corrosion resistant material such as stainless steel. While it is to be understood that the grooming teeth 110 may be constructed so as not to substantially deflect along the length of the grooming teeth 110, the grooming teeth 110 may be affixed to the head portion 102 in a manner than allows for some deflection (e.g., pivoting) of the grooming teeth 110 with respect to the head portion 102. Allowing some small deflection of the grooming teeth 110 with respect to the head portion 102 may prevent the grooming teeth 110 from pulling matted or tangled hair in a manner that may hurt the animal being groomed. For example, grooming teeth may be attached to a resilient rubber pad (e.g., a slicker pad) that is mounted to the head portion, enabling the grooming teeth to pivot slightly with respect to the head portion. However, the grooming teeth 110 should not deflect with respect to the head portion 102 to a degree that substantially hinders fur removal due to the deflection of the grooming teeth 110 with respect to the head portion 102.

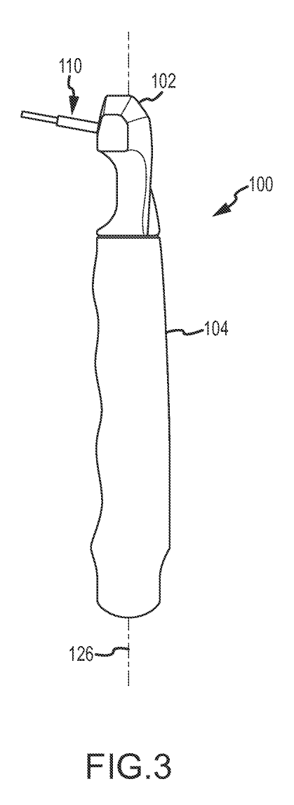

Turning to FIG. 3, a side view of the undercoat rake 100 is shown. As can be appreciated, the grooming teeth 110 may extend away from the head portion 102. The grooming teeth 110 may be slightly angled from a perpendicular orientation in relation to the longitudinal axis 126 of the handle portion 104. For example, as illustrated in FIG. 3, the grooming teeth 110 are disposed at an obtuse angle with respect to the longitudinal axis 126 of the handle portion 104. In any event, the grooming teeth 110 may be disposed so as to be capable of engaging the fur of an animal while a user grasps the handle portion 104 in order to manipulate the undercoat rake 100.

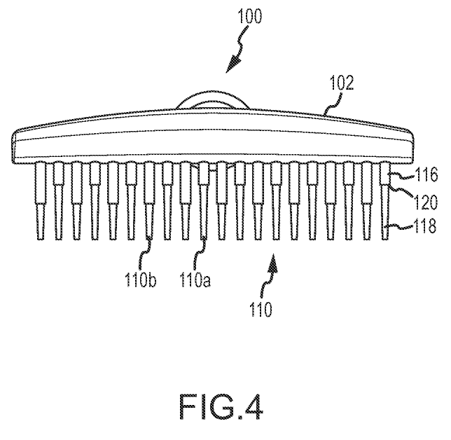

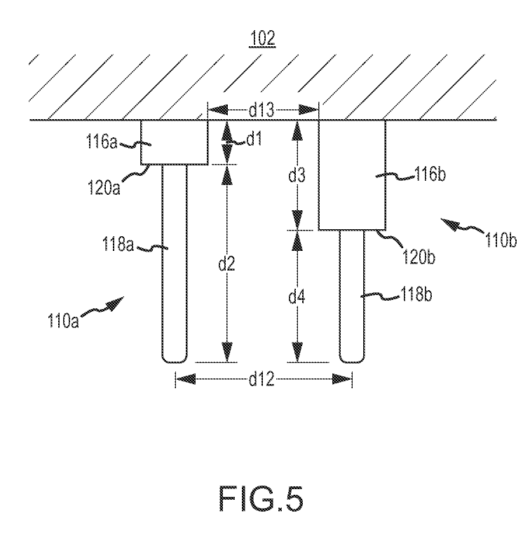

With reference to FIGS. 4 and 5, the grooming teeth 110 may generally include a base portion 116 and a tip portion 118 that may be separated by a shoulder 120. The base portions 116 of the grooming teeth 110 may be adjacent to the head portion 102 and extend therefrom, such that the base portions 116 may comprise a proximate end of the grooming teeth 110. The grooming teeth 110 also may include a tip portion 118 that is arranged at a distal end of the grooming teeth 110. A shoulder 120 may separate the tip portion 118 and the base portion 116 of the grooming teeth 110. As illustrated in FIGS. 4-5, the shoulder 120 comprises an annular step that separates the tip portion 118 from the base portion 116. A shoulder may also comprise, for example, shapes other than an annular step, such as a frustoconical shape between a tip portion and a base portion, for example. In any event, the shoulder 120 comprises the transition from the base portion 116 to the tip portion 118.

In this regard, the base portion 116 may have a different cross dimension (e.g., diameter) than the tip portion 118. For instance, the tip portion 118 may have a smaller cross dimension than the base portion 116. In one embodiment, the tip portion 118 may have a cross dimension of at least about 30% and not greater than about 70% of a cross dimension of the base portion 116. Additionally, the base portion 116 may have a cross dimension of at least about 2 mm and not greater than about 6 mm. The tip portion 118 may have a cross dimension of at least about 0.5 mm and not greater than about 4 mm. In one embodiment, the base portion 116 and the tip portion 118 have a circular cross-section and the cross dimension is equivalent to the diameter of the portions. Other cross-sectional shapes of the tip portion and base portion may be employed, such as an oval cross-section or a polygonal cross-section.

Referring to FIG. 5, the tip portion 118a of first teeth 110a may be of a different length than the tip portion 118b of second teeth 110b. When the grooming teeth have substantially the same total length, the length of the base portions (e.g., the distance of the shoulder from the head portion) will therefore also be different. The base portion 116a of first teeth 110a may have a length d1 and the tip portion 118a of first teeth 110a may have a length d2. The base portion 116b of second teeth 110b may have a length d3 and the tip portion 118b of second teeth 110b may have a length d4. In this embodiment, d2 may be greater than d4. As such, first teeth 110a may have a longer tip portion 118a than a tip portion 118b of second teeth 110b. Additionally, d1 may be less than d3. In turn, second teeth 110b may have a longer base portion 116b than a base portion 116a of first teeth 110a. In this particular embodiment, first teeth 110a and second teeth 110b may have substantially the same total length.

The grooming teeth 110 should be of sufficient total length to effectively groom a furred animal such as a dog. By way of example, the total length of first teeth 110a and second teeth 110b (e.g., d1+d2) may be at least about 10 mm and not greater than about 40 mm, such as not greater than about 25 mm. To form a variable depth grooming profile, the length d2 of the tip portion 118a of first teeth 110a may be at least about 15% longer than the length d4 of the tip portion 118b of second teeth 110b, such as at least about 30% longer. For example, the length d2 of tip portion 118a may be at least about 5 mm and not greater than about 30 mm and the length d4 of the tip portion 118b may be at least about 4 mm and not greater than about 25 mm, while being less than the length d2 of the tip portion 118a. The length d1 of the base portion 116a may be at least about 4 mm and not greater than about 25 mm and the length d3 of the base portion 116b may be at least about 5 mm and not greater than about 30 mm, while being greater than the length d1 of the base portion 116a.

The grooming teeth should also be spaced sufficiently close together to enable efficient grooming of the furred animal. In this regard, the grooming teeth 110 may be spaced apart from adjacent grooming teeth 110 by a distance d12 as measured between the centers of the tip portions 118. The distance d12 may be substantially the same between all adjacent grooming teeth 110 or the distance d12 may be different for different adjacent grooming teeth 110. By way of example, the distance d12 may be at least about 3 mm and not greater than about 8 mm. Furthermore, the base members 116 may be separated by a distance d13 corresponding to the shortest distance between outer surfaces (e.g., edge to edge) of adjacent base portions. For example, the distance d13 may be at least about 2 mm and not greater than about 5 mm. The distance d13 may be the same between all adjacent base portions 116 or may vary between the outer surfaces of adjacent base portions 116.

In one embodiment, there may be provided grooming teeth in addition to first teeth 110a and second teeth 110b such that additional grooming teeth may be included in the undercoat rake 100. In this regard, if additional grooming teeth are included, the additional grooming teeth may include portions (e.g., base portions and tip portions) corresponding to the portions that were described above regarding first teeth 110a and second teeth 110b. The additional grooming teeth may have corresponding grooming teeth portions with different dimensions (e.g., grooming depth profile) than either first teeth 110a or second teeth 110b, or the additional grooming teeth may share common dimensions with either first teeth 110 or second teeth 110b for some corresponding portions.

In another embodiment, grooming teeth may have different (e.g., fewer or more) portions than the grooming teeth 110 (e.g., a central portion disposed between a base portion and a tip portion and separated from each by a shoulder).

First teeth 110a and second teeth 110b may be disposed along the length of the head portion 102 such that the grooming teeth 110 may be alternately disposed along at least a portion thereof. By alternately disposed, it is meant that first teeth 110a and second teeth 110b are operatively disposed in any alternating or semi-alternating arrangement along the length of the head portion 102 such that at least one first tooth is disposed adjacent to at least one second tooth. For instance, as illustrated in FIG. 4, first teeth 110a and second teeth 110b may be alternately disposed along a substantially linear row such that every other grooming tooth along the length of the head portion 102 is the same, with a different tooth disposed therebetween. In this regard, the grooming teeth 110 may strictly alternate such that first teeth 110a may alternate with second teeth 110b and each adjacent tooth is different. Alternatively, first teeth 110a or second teeth 110b may be repeated for a number of grooming teeth positions (e.g., two adjacent positions) such that a first tooth 110a or a second tooth 110b is adjacent to one or more of the same type of grooming teeth 110. This may result in repeating and/or alternating first teeth 110a and second teeth 110b along the length of the head portion 102. In sum, first teeth 110a and second teeth 110b may be arranged in any pattern or sequence of first teeth 110a and second teeth 110b along the length of the head portion 102 to form a varied depth profile.

The grooming rake 100 may include a total number of grooming teeth generally between 10 and 30 total teeth. In one embodiment, the grooming rake 100 includes a total number of grooming teeth between 15 and 25 total teeth.

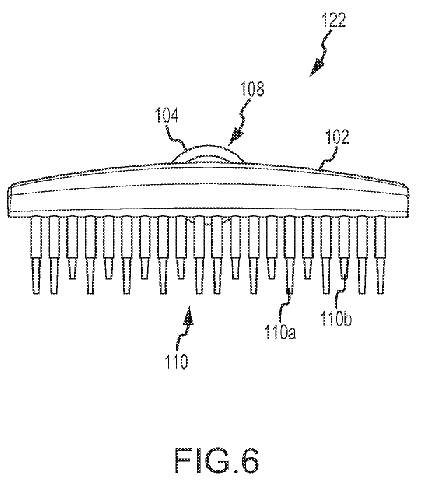

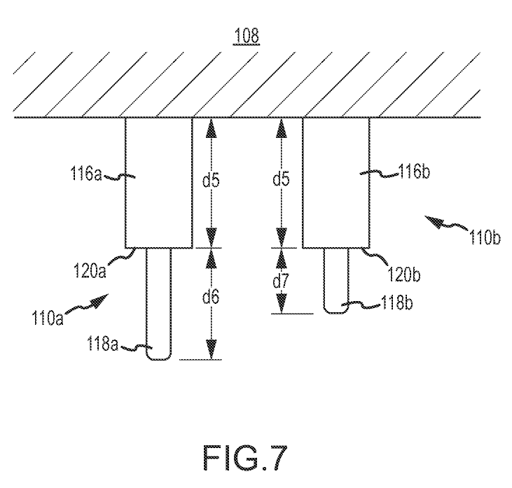

FIGS. 6 and 7 show an alternative embodiment of an undercoat rake 122. The undercoat rake 122 may have a rake body 108 including a handle portion 104 and a head portion 102 similar to the handle portion 104 and head portion 102 referenced and described with respect to FIGS. 1-4. The undercoat rake 122, like the undercoat rake 100, may include a plurality of grooming teeth 110 that project from the rake body 108.

FIG. 7 is a schematic view of first teeth 110a and second teeth 110b that are useful in the undercoat rake 122. First teeth 110a and second teeth 110b may have a base portion 116 that extends from the head portion 102 and a tip portion 118 at a distal end. The tip portion 118 may be separated from the base portion 116 by a shoulder 120.

In this embodiment, the base portion 116a of first teeth 110a may extend for substantially the same length away from the head portion 102 as the base portion 116b of second teeth 110b. In this regard, both base portions 116 of the grooming teeth 110 may have a length d5. The length d6 of the tip portion 118a of first teeth 110a may be longer than the length d7 of the tip portion 118b of second teeth 110b. The base portions 116 of the grooming teeth 110 may be substantially the same length, while the tip portions 118 may have different lengths. Accordingly, the total lengths (e.g., d5+d6 or d5+d7) of first teeth 110a and second teeth 110b may be different for the undercoat rake 122.

Grooming teeth 110 may be disposed along the length of the head portion 102 such that the grooming teeth 110 are alternately disposed along at least a portion thereof. In this regard, first teeth 110a and second teeth 110b may be intermixed along the length of the head portion 102 as was described with reference to the embodiment of FIGS. 1-5. As such, second teeth 110b may separate pairs of first teeth 110a at certain positions along the length of the head portion 102. However, with reference to the ends of the head portion 102 as shown in FIG. 6, for example, some first teeth 110a may be adjacent. Also, while not shown, some second teeth 110b may be positioned adjacent to one another.

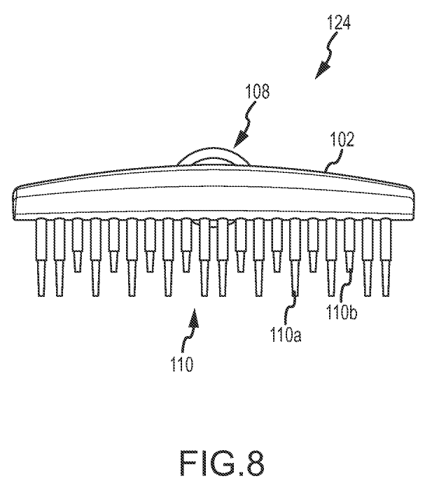

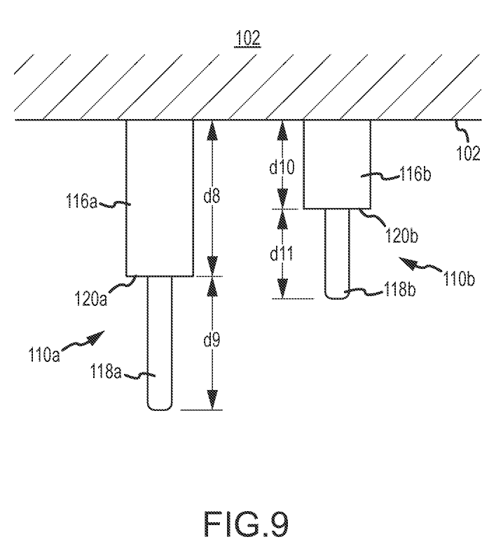

Another alternative embodiment of an undercoat rake 124 is shown in FIGS. 8 and 9. In FIG. 9, first teeth 110a and second teeth 110b of the undercoat rake 124 are shown. First teeth 110a may have a base portion 116a that may extend from the head portion 102 for a length d8. First teeth 110a also may have a tip portion 118a at a distal end that may extend for a length d9. A shoulder 120a may be arranged between the base portion 116a and the tip portion 118a of first teeth 110a. Second teeth 110b may also have a base portion 116b extending from the head portion 102 and may have a length d10. Second teeth 110b may include a tip portion 118b with a length d11. The tip portion 118b and the base portion 116b may be separated by a shoulder 120b.

In this embodiment, the total length of first teeth 110a (e.g., d8+d9) may be greater than that of second teeth 110b. In this regard, both the length d9 of the tip portion 118a and the length d8 of the base portion 116a may be longer than the length d11 of the tip portion 118b and the length d10 of the base portion 116b of second teeth 110b, respectively.

As discussed above, first teeth 110a and second teeth 110b of the undercoat rake 124 may be alternately disposed along the length of the head portion 102 such that two first teeth 110a repeat, followed by alternating first teeth 110a and second teeth 110b. First teeth 110a and second teeth 110b may alternate in any manner.

Any of the forgoing embodiments of an undercoat rake may be used in a method of grooming a furred animal. The method may include a user grasping the handle portion of an undercoat rake and placing the undercoat rake adjacent to a furred animal such that grooming teeth affixed to the head portion are generally disposed within the animal's fur. The undercoat rake may then be moved along the furred animal's body such that the grooming teeth remain in contact with the animal's fur such that the animal's fur passes between the grooming teeth. In turn, as the animal's fur passes between the grooming teeth of the undercoat rake, loose hair or soon to be shed hair may be removed from the animal's fur.

In sum, the embodiments presented herein include grooming teeth operatively affixed to a rake body. The grooming teeth include a base portion and a tip portion separated by a shoulder. The grooming teeth have different tip portion lengths such that some grooming teeth have a longer tip portion than other grooming teeth (e.g., have a different grooming depth profile). As such, a variable depth grooming profile along the rake body is presented when grooming a furred animal. The undercoat rakes presented herein are generally advantageous for grooming of furred animals due, at least in part, to the variable depth grooming profiles of the grooming teeth as it has been found that the variable depth grooming profiles may facilitate improved undercoat fur removal.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. An undercoat rake for grooming a furred animal, the undercoat rake comprising:
a rake body; and
grooming teeth operatively affixed to the rake body, the grooming teeth comprising:
a plurality of first teeth, the first teeth having a base portion adjacent to and extending from the rake body, a tip portion at a distal end, and a shoulder disposed between the base portion and the tip portion, and
a plurality of second teeth, the second teeth having a base portion adjacent to and extending from the rake body, a tip portion at a distal end, and a shoulder disposed between the base portion and the tip portion;
wherein the length of the tip portion of the first teeth is greater than the length of the tip portion of the second teeth.

2. The undercoat rake of claim 1, wherein the rake body comprises at least a head portion having a length along a major axis of the head portion, and wherein the grooming teeth are affixed to the rake body along the length of the head portion.

3. The undercoat rake of claim 2, wherein the first teeth and the second teeth are alternately disposed along at least a portion of the length of the head portion.

4. The undercoat rake of claim 3, wherein the first teeth and the second teeth alternate at adjacent tooth positions along at least a portion of the length of the head portion.

5. The undercoat rake of claim 3, wherein adjacent grooming teeth are spaced apart by at least about 2 mm and not greater than about 6 mm.

6. The undercoat rake of claim 3, wherein at least one of the second teeth is disposed adjacent to two of the first teeth.

7. The undercoat rake of claim 2, wherein the rake body further comprises a handle portion that is adapted to be gripped by a user.

8. The undercoat rake of claim 7, wherein the major axis of the head portion is substantially perpendicular to a longitudinal axis of the handle portion.

9. The undercoat rake of claim 1, wherein the total length of the first teeth and the total length of the second teeth are substantially the same.

10. The undercoat rake of claim 9, wherein the total length of the first teeth and the total length of the second teeth is at least about 10 mm and not greater than about 40 mm.

11. The undercoat rake of claim 1, wherein the total length of the first teeth and the total length of the second teeth are different.

12. The undercoat rake of claim 1, wherein the grooming teeth are substantially rigid.

13. The undercoat rake of claim 12, wherein the grooming teeth are metallic.

14. The undercoat rake of claim 13, wherein the grooming teeth are stainless steel.

15. The undercoat rake of claim 1, wherein the tip portion of the first teeth is at least 15% longer than the tip portion of the second teeth.

16. The undercoat rake of claim 15, wherein the length of the tip portion of the first teeth is at least about 5 mm and the length of the tip portion of the second teeth is not greater than about 30 mm.

17. The undercoat rake of claim 1, wherein the base portions of the grooming teeth have a cross dimension that is at least about 2 mm and not greater than about 6 mm.

18. The undercoat rake of claim 17, wherein the tip portion of the grooming teeth have a cross dimension that is at least about 0.5 mm and not greater than about 4 mm.

19. An undercoat rake for grooming a furred animal, the undercoat rake comprising:
a rake body comprising a head portion having a length along a major axis of the head portion and a handle portion having a longitudinal axis, the major axis being substantially perpendicular to the longitudinal axis;
grooming teeth operatively affixed to the head portion, the grooming teeth comprising:
a plurality of first teeth, the first teeth having a base portion adjacent to and extending from the rake body, a tip portion at a distal end, and a shoulder disposed between the base portion and the tip portion, and
a plurality of second teeth alternately disposed with the first teeth along the length of the head portion, the second teeth having a base portion adjacent to and extending from the rake body, a tip portion at a distal end, and a shoulder disposed between the base portion and the tip portion;
wherein the length of the tip portion of the first teeth is greater than the length of the tip portion of the second teeth and wherein the total length of the first teeth and the total length of the second teeth are substantially the same.

20. A method for grooming a furred animal, the method comprising:
providing an undercoat rake according to claim 1;
positioning the undercoat rake adjacent to the furred animal such that the grooming teeth engage fur of the furred animal; and
moving the undercoat rake with respect to the furred animal while maintaining engagement of the grooming teeth with the fur such that the grooming teeth act upon the fur passing therebetween to remove loose hairs therefrom, thus grooming the animal.
